(19) United States
(12) Patent Application Publication
(10) Pub. No.: US 2021/0038926 A1
(43) Pub. Date: Feb. 11, 2021

(54) BREATHABLE GAS AND WATER HOSE APPARATUS

(71) Applicant: 1005, LLC, Birmingham, MI (US)

(72) Inventor: Pat J. REEDY, Grand Ledge, MI (US)

(21) Appl. No.: 16/965,141

(22) PCT Filed: Feb. 4, 2019
(86) PCT No.: PCT/US2019/016501

§ 371 Date: Jul. 27, 2020

Related U.S. Application Data
(60) Provisional application No. 62/626,760, filed on Feb. 6, 2018.

(51) Int. Cl. A62B 7/02; A62C 33/00

(52) U.S. Cl. CPC A62B 7/02; A62B 9/02; A62C 33/00

(57) ABSTRACT

The present invention provides a system which allows a hose apparatus to be used to deliver water and air to the user at all times, eliminating the need for users to rely on breathable gas supplied by tanks. The invention includes the use of a breathable gas hose in the interior of the jacket of the water hose such that both breathable gas and water are delivered through the hose apparatus simultaneously. The breathable gas hose is protected within an outer jacket surrounding the water hose. The system allows for easy connect and disconnect of the air supply to the user's breathing apparatus and can be used with standard self-contained breathing apparatus (SCBA) typically used by firefighters. The system, however, overrides the SCBA system such that the user does not have to manually switch between the breathable gas and water hose apparatus and an SCBA system.

### BACKGROUND

### 1. Field

The present invention relates to a breathable gas and water hose apparatus and the method of using the breathable gas and water hose apparatus for use in a system to supply breathable gas and water to individuals in need of an air supply while dispensing water, for example a firefighter in a fire. In particular, the present invention relates to a hose apparatus which includes both a water hose and a breathable gas hose which connects to the breathing apparatus of the user to provide a constant source of air to the user.

One of the main reasons that firefighters face such danger in fighting fires is that they run out of air. Typically, air is supplied to a firefighter by tanks carried on the firefighter's back. These tanks have a limited air supply, which in turn limits a firefighter's ability to fight fires for an extended period of time without running out of air. Firefighters trapped or lost in a flaming structure usually die when their air runs out.

U.S. Pat. No. 6,520,178 sought to solve this problem by combining a water hose and air hose, disclosing two air hoses located within a water hose. This patent further disclosed a system allowing for easy connect and disconnect of the air supply to the firefighter's mask that could be used with standard self-contained breathing apparatus (SCBA) used by firefighters and including a mask and a regulator. However, the system disclosed no mechanism for the use of the hose in conjunction with the typically used air tanks. In the event that a user needed to switch from the hose to the tanks, he or she would have to manually disconnect the hose and reconnect the SCBA system.

There remains the need for a system for supplying breathable gas to a user from a distant source having a breathable gas hose together with the water hose which allows for high pressure air to be delivered to users without interfering with the flow of the water in the water hose and wherein the flow of air is not contingent on the flow of water.

### SUMMARY

The present invention provides a system which allows a hose apparatus to be used to deliver water and air to the user at all times. The system eliminates the need for users to rely on the limited amount of breathable gas supplied by traditional tanks during the time that they are using the invention. The system could also result in users carrying smaller air tanks which equates to less weight carried by the user. The present invention includes the use of a breathable gas hose in the interior of the jacket of the water hose such that both breathable gas and water are delivered through the hose apparatus simultaneously. The breathable gas hose apparatus comprises only a single section of the overall water hose of the system. This ensures that no part of the breathable gas hose extends outside the water hose and is exposed to possible damage. While the breathable gas hose is not threaded through the water hose, it is entirely protected within an outer jacket surrounding the water hose. The present system can be used as a primary air supply system allowing the air tanks carried by the user to be used only for emergency purposes. The system supplies high pressure breathable gas similar to that supplied by the tanks carried by firefighters. The system allows for easy connect and disconnect of the air supply to the user's breathing apparatus and can be used with standard self-contained breathing apparatus (SCBA) typically used by firefighters, and including a mask and a regulator.

Additionally, the system has the ability to override the standard SCBA system such that the user does not have to manually switch between the breathable gas and water hose apparatus and an SCBA system. A typical SCBA tank used with the system has two regulators. One of the regulators dispenses air at 100 to 110 psi. If there is another source of higher air pressure, a valve connected to the regulator allows the higher air pressure to be a primary source. The system, then, is configured to dispense air at pressures higher than 110 psi. When the system fails or runs out of air, the valve automatically opens to allow air from the SCBA tanks to be dispensed as the primary source of air.

The present invention relates to a hose apparatus having an inlet end; an outlet end; a first hose end connector attached to the inlet end having a first passageway and a second passageway; a second hose end connector attached to the outlet end having a third passageway and a fourth passageway; a flexible water hose between and connected to the first passageway on the inlet end and the third passageway on the outlet end in a water tight connection: a flexible gas hose between and connected to the second passageway and the fourth passageway in a gas tight connection, adjacent to but external to the flexible water hose; and an outer jacket made of weather-resistant material, surrounding both the flexible water hose and the flexible gas hose.

Further, the invention discloses the hose apparatus further comprising a first connection on the first hose end connector for connecting a source of water through the first passageway, the flexible water hose, and the third passageway; a second connection on the first hose end connector for connecting a source of breathable gas through the second passageway, the flexible gas hose, and the fourth passageway, the second connection having a valve for sealing the inlet end when disconnected and for providing breathable gas when connected to the source of breathable gas; a third connection on the second hose end connector for connecting the breathable gas to a pressure regulator as part of a user's breathing apparatus, and a fourth connection on the second hose end connector connecting a nozzle for dispensing water connected to the third passageway.

Further, the present invention relates to a system which allows a hose apparatus to be used to deliver water and air to the user at all times, the system comprising a hose having an inlet end; an outlet end; a first hose end connector attached to the inlet end having a first passageway and a second passageway; a second hose end connector attached to the outlet end having a third passageway and a fourth passageway; a flexible water hose between and connected to the first passageway on the inlet end and the third passageway on the outlet end in a water tight connection: a flexible gas hose between and connected to the second passageway and the fourth passageway in a gas tight connection, adjacent to but external to the flexible water hose; an outer jacket made of weather-resistant material, surrounding both the flexible water hose and the flexible gas hose; a first connection on the first hose end connector for connecting a source of water through the first passageway, the flexible water hose, and the third passageway; a second connection on the first hose end connector for connecting a source of breathable gas through the second passageway, the flexible gas hose, and the fourth passageway, the second connection having a valve for sealing the inlet end when disconnected and for providing breathable gas when connected to the source of breathable gas; a third connection on the second hose end connector for connecting the breathable gas to a pressure regulator as part of a user's breathing apparatus, and a fourth connection on the second hose end connector connecting a nozzle for dispensing water connected to the third passageway.

The present invention further relates to a system comprising the use of air tanks carried on the back of a user in conjunction with the hose apparatus, such that the apparatus provides gas at a pressure of at least 110 psi and wherein the air tanks include a pressure regulator and a valve which opens when air pressure from the apparatus is below 110 psi.

Still further, the present invention relates to a method for fighting a fire or otherwise providing a source of water to a point which comprises the steps of: providing a hose apparatus having an inlet end; an outlet end; a first hose end connector attached to the inlet end having a first passageway and a second passageway; a second hose end connector attached to the outlet end having a third passageway and a fourth passageway; a flexible water hose between and connected to the first passageway on the inlet end and the third passageway on the outlet end in a water tight connection; a flexible gas hose between and connected to the second passageway and the fourth passageway in a gas tight connection, adjacent to but external to the flexible water hose; an outer jacket made of weather-resistant material, surrounding both the flexible water hose and the flexible gas hose; a first connection on the first hose end connector for connecting a source of water through the first passageway, the flexible water hose, and the third passageway; a second connection on the first hose end connector for connecting a source of breathable gas through the second passageway, the flexible gas hose, and the fourth passageway, the second connection having a valve for sealing the inlet end when disconnected and for providing breathable gas when connected to the source of breathable gas; a third connection on the second hose end connector for connecting the breathable gas to a pressure regulator as part of a user's breathing apparatus, and a fourth connection on the second hose end connector connecting a nozzle for dispensing water connected to the third passageway; connecting the inlet end of the hose apparatus to a water source and a source of breathable gas; and connecting the apparatus to a pressure regulator on the breathing apparatus using the flexible gas hose, and providing the breathable gas to the user from the hose apparatus through the pressure regulator on the breathing apparatus by using the flexible gas hose at least part of the time the user is fighting the fire or otherwise providing a source of water to a point.

The substance and advantages of the present invention will become increasingly apparent by reference to the following drawings and the description.

### BRIEF DESCRIPTION OF THE DRAWINGS

Other advantages of the system and method of the present disclosure will be readily appreciated, as the same becomes better understood by reference to the following Detailed Description when considered in connection with the accompanying drawings wherein:

FIG. 1 is a perspective view of the system 100 showing a fire truck 116, a breathable gas and water hose apparatus 101 and a user 150.

FIG. 2 is a cross-sectional view of the breathable gas and water hose apparatus 101, showing the water hose 1 and breathable gas hose 3 inside of an outer jacket 2.

FIG. 3A shows a top view of a nozzle adaptor 8.

FIG. 3B shows a plan view of the nozzle adaptor 8.

FIG. 3C shows a side view and partial cross-section of the nozzle adaptor 8.

FIG. 4A shows a top view of an inlet hose end connector 4.

FIG. 4B shows a plan view of the inlet hose end connector 4.

FIG. 4C shows a side view and partial cross-section of the inlet hose end connector 4.

FIG. 5A a top view of an outlet hose end connector 5.

FIG. 5B shows a plan view of the outlet hose end connector 5.

FIG. 5C shows a side view and partial cross-section of the outlet hose end connector 5.

FIG. 5D shows the cross-section A-A of FIG. 5A of the outlet hose end connector 5.

FIG. 6 shows an exploded view of the breathable gas and water hose apparatus 101.

FIG. 7 shows a view of a user 150 operating the breathable gas and water hose apparatus 101.

FIG. 8 shows a wireframe view of a user 150 operating the breathable gas and water hose apparatus 101.

FIG. 9 shows a view of an air tank 42 which could be used in conjunction with the breathable gas and water hose apparatus 101.

### DETAILED DESCRIPTION

Referring to the Figures, wherein like numerals indicate corresponding parts throughout the several views:

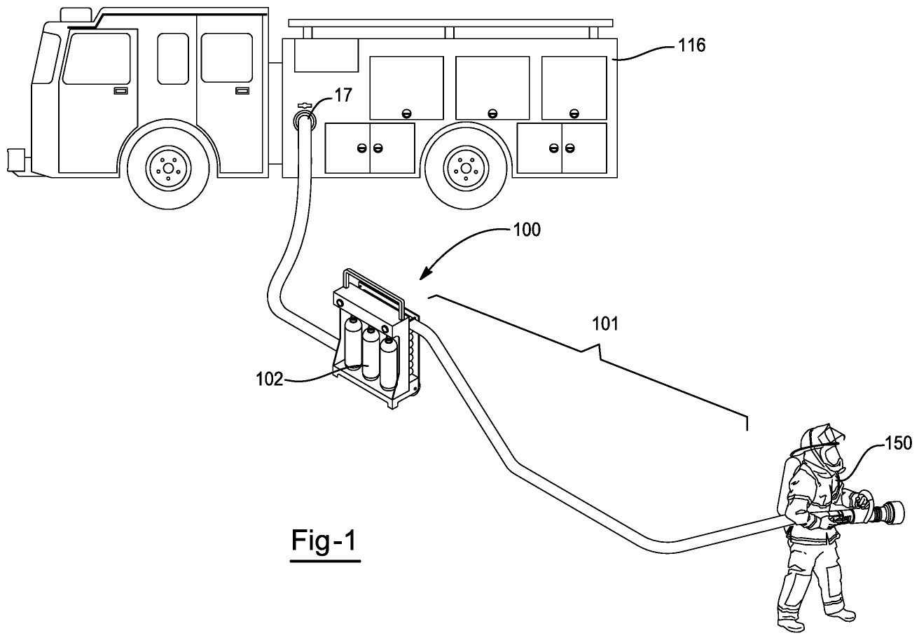

FIG. 1 shows the breathable gas and water hose apparatus 101 of the present invention in use in an air supply system 100 to provide air or other breathable gas to users 150. The air supply system 100 includes a breathable gas and water hose apparatus 101 connected at one (1) end to an air supply 102 and connected at the other end to a self-contained breathing apparatus (SCBA) 152.

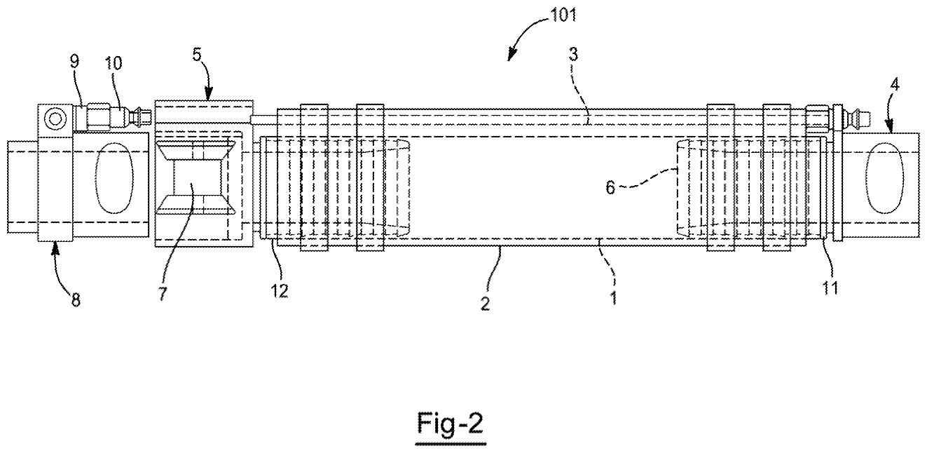

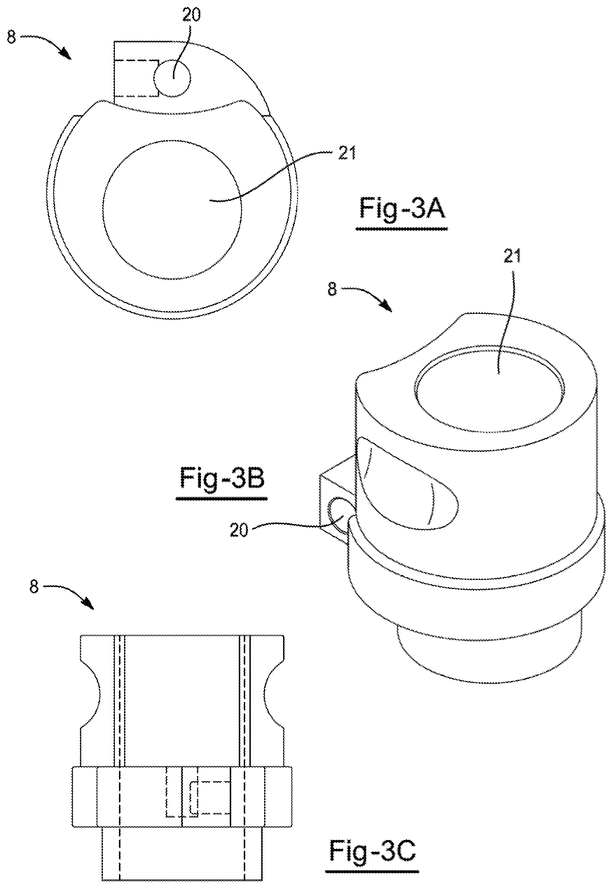

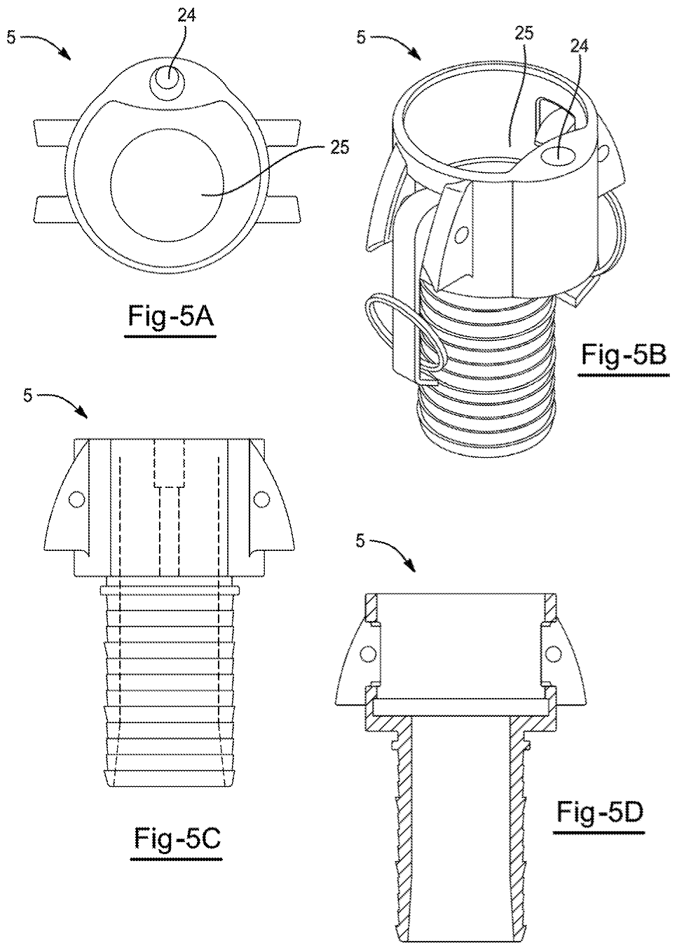

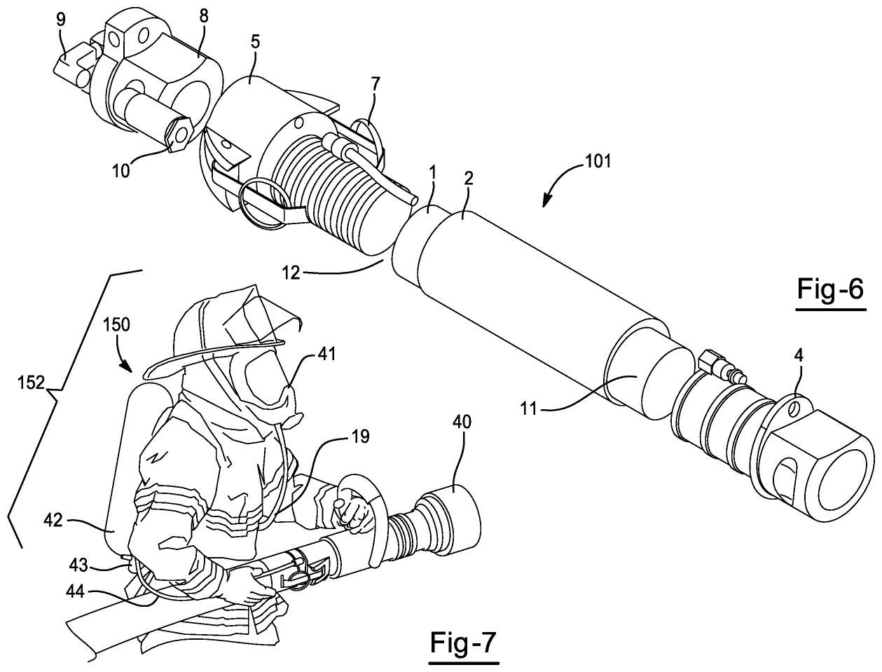

FIG. 2 shows the breathable gas and water hose apparatus 101, having an inlet end 11 and an outlet end 12, attached to an inlet hose end connector 4 and an outlet hose end connector 5. The inlet hose end connector 4 has a first passageway 23 and second passageway 22. FIGS. 5A-D show the outlet hose end connector 5 has a third passageway 25 and fourth passageway 24. A flexible water hose 1 is connected to the first passageway 23 and the third passageway 25 in a water tight connection. The water hose 1 is preferably similar to standard firefighting water hoses and is preferably constructed of several layers of materials which are durable and flexible. A flexible gas hose 3 is connected to the second passageway 22 and the fourth passageway 24 in a gas tight connection. The flexible gas hose 3 is adjacent to but external to the flexible water hose 1. An outer jacket 2 surrounds both the flexible water hose 1 and flexible gas hose 3. The flexible gas hose 3 may be constructed of any well-known material which can withstand high fluid pressure on the outside caused by the flow of water through the water hose 1 and high fluid pressure on the inside caused by the air moving through the gas hose 3. In one (1) embodiment, the gas hose 3 is constructed of reinforced rubber tubing which is approved for human use. The ability of the gas hose 3 to carry breathable gas up to 5000 psig enables the gas hose 3 to be used as a means to fill the air tanks of the users. Also, preferably, the gas hose 3 is constructed of a material which does not have memory. The gas hose 3 must be supple enough to bend 180° and still spring back to its original shape to prevent damage to the gas hose 3 due to repeated bending and folding for storage. The gas hose 3 must also be constructed of a material which will not contaminate the air such as air hoses used and approved for scuba diving.

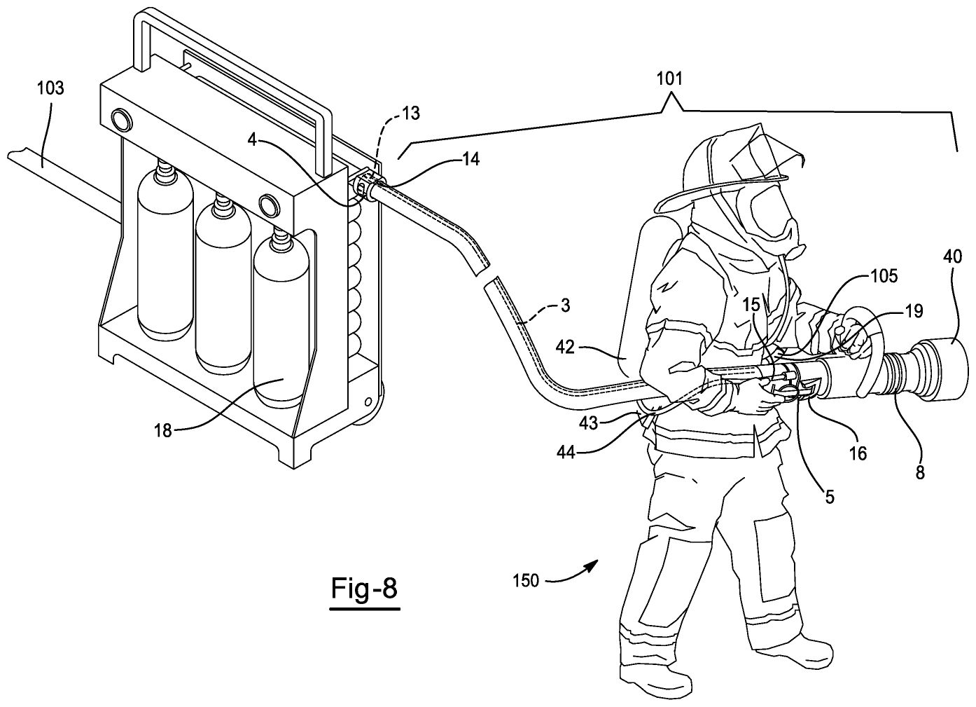

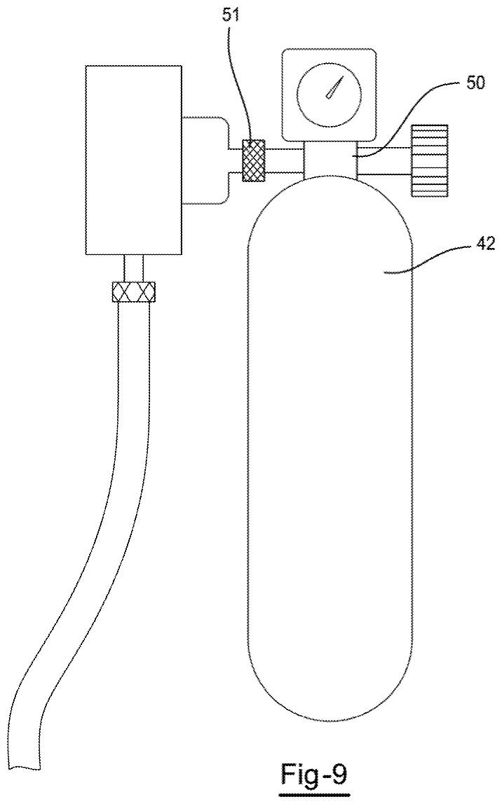

FIG. 8 shows a first connection 13 on the inlet hose end connector 4 for connecting a source of water 17 through the first passageway 23, the flexible water hose 1, and the third passageway 25. A second connection 14 on the first hose end connector 4 connects a source of breathable gas 18 through the second passageway 22, the flexible gas hose 3, and the fourth passageway 24. A third connection 15 on the second hose end connector 5 connects the breathable gas hose 3 to a pressure regulator 19 as part of a user's breathing apparatus 152, and a fourth connection 16 on the second hose end connector connects a nozzle adaptor 8 for dispensing water connected to the third passageway.

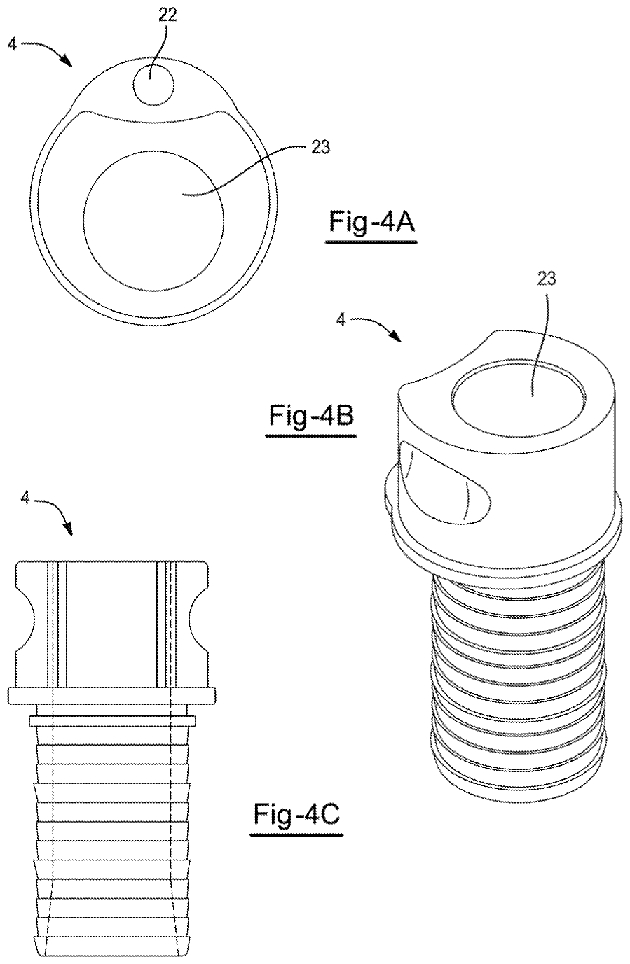

As shown in FIG. 4, the inlet hose end connector's first passageway 23 is larger than the second passageway 22. The first passageway 23 connects a source of water to the flexible water hose 1. The second passageway 22, located above and separate from the first passageway 23, connects a source of breathable gas to the flexible gas hose 3.

The third passageway 25 is larger than the fourth passageway 24. The third passageway 25 connects the flexible water hose 1 to a nozzle adaptor 8 in a sealingly secured manner. The fourth passageway 24, located above and separate from the third passageway 25, connects the flexible gas hose 3 to a pressure regulator 105 as part of a breathing apparatus, also in a sealingly secured manner.

The nozzle adaptor 8 is mounted on the outlet hose end connector 5. The inlet hose end connector 4 can be connected to a water source or can be connected to a standard firefighting or other purpose water hose.

FIG. 7 shows the breathing apparatus 152 for the user 150 preferably includes a first breathing hose 44, a regulator (not shown) and a breathing mask 41 and at least one (1) air tank 42 carried on the back of the user. In the preferred embodiment, the breathing hose 44 extends between the air tank 42 and the regulator and provides air from the tank 42 to the user 150. In one (1) embodiment, the regulator is directly mounted on the breathing apparatus 152. The regulator allows high pressure, compressed gas to be used as the air supply.

The breathable gas and water hose apparatus 101 may be used in the primary breathing system or source of breathable gas for users 150 fighting a fire or otherwise delivering a source of water to a point. The breathable gas and water apparatus 101 is used as the last section of the water hose 1 used by the users 150. Limiting use of the breathable gas and water hose apparatus 101 to a single section of the water hose 1 eliminates the need to connect the breathable gas hose 44 from several air and water hose apparatuses 101 together. This reduces the risk of gas leakage and also reduces the possibility of damage to the gas hose 3 which could result in gas leakage. Gas leakage in high pressure compressed gas systems could potentially be dangerous since the leaked gas could feed a fire. Any number of standard water hoses can be used to allow the needed length provided the last hose is the breathable gas and water hose apparatus 101. In the preferred embodiment, the breathable gas and water hose apparatus 101 has a length of between 50 and 150 feet (127 and 254 cm). However, it is understood that the breathable gas and water hose apparatus 101 can be of any length.

To use the breathable gas and water hose apparatus 101 in the air supply system 100, the first passageway 23 of the gas and water apparatus 101 is attached to the outlet adaptor of the last section of a standard water hose 103. The inlet end of the standard water hose 103 is connected to a source of water. Alternatively, if only the breathable gas and water hose apparatus is used, the first passageway 23 of the inlet hose end connector 4 of the breathable gas and water hose apparatus 101 is connected directly to a source of water.

The air supply 100 is preferably positioned adjacent the inlet hose end connector 4 of the breathable gas and water hose apparatus 101. The air supply tube for the air supply is then connected to the plug on the inlet hose end connector 4. In the preferred embodiment, the air supply 102 provides breathable gas at a pressure of at least 200 psig with or without the use of a regulator 105. However, it is understood that the pressure of the breathable gas entering the second passageway 22 in the inlet hose end connector 4 must be great enough to provide sufficient breathable gas to the user 150 at the other end of the breathable gas and water hose apparatus 101. How much pressure is needed would depend on the length of the breathable gas and water hose apparatus 101, and the inner diameter of the breathable gas hose 3 and the number of persons using the breathable gas and water hose apparatus 101.

Air tanks 42 carried on the back of a user 150 may be used in conjunction with the hose apparatus 101, such that the apparatus 101 provides gas at a pressure of at least 110 psi and wherein the air tanks 42 include a pressure regulator 50 and a valve 51 which opens when air pressure from the apparatus 101 is below 110 psi.

It is understood that other breathable gases could also be provided through the breathable gas hose 3 of the breathable gas and water hose apparatus 101. It is also understood that other fluids could also be provided through the water hose 1 of the breathable gas and water hose apparatus 101, including but not limited to other firefighting fluids or flame-retardant materials, or other fluids used for applications unrelated to firefighting.

A secondary hose and breathing apparatus (not shown) could also be connected to any remaining plug. The secondary hose and breathing apparatus could then be used to provide breathable gas to a civilian trapped in a fire.

With reference to FIG. 7, once the users 150 are connected to the breathable gas and water hose apparatus 101 and are holding the nozzle 40, the water supply is turned on. The water running through the water hose 1 is preferably at a pressure of between about 1000 and 2850 psig. The water pressure is preferably similar to that used in standard water hoses. The system 100 is preferably constructed such that the user 150 breathes air or other breathable gas from the breathable gas and water hose apparatus 101 as long as the air supply 102 is available. Thus, a user 150 would only use the breathable gas in the tank 42 of his breathing apparatus 152 which he carries, if the primary air supply 102 is stopped.

It is intended that the foregoing description be only illustrative of the present invention and that the present invention be limited only by the hereinafter appended claims.

Obviously, many modifications and variations of the present invention are possible in light of the above teachings and may be practiced otherwise than as specifically described while within the scope of the appended claims.

What is claimed is:

1. A hose apparatus, comprising
(a) an inlet end;
(b) an outlet end;
(c) a first hose end connector attached to the inlet end having a first passageway and a second passageway;
(d) a second hose end connector attached to the outlet end having a third passageway and a fourth passageway;
(e) a flexible water hose between and connected to the first passageway on the inlet end 23 and the third passageway on the outlet end in a water tight connection:
(f) a flexible gas hose between and connected to the second passageway and the fourth passageway in a gas tight connection, adjacent to but external to the flexible water hose; and
(g) an outer jacket made of weather-resistant material, surrounding both the flexible water hose 1 and the flexible gas hose, collectively.

2. The apparatus of claim 1, further comprising:
(a) a first connection on the first hose end connector for connecting a source of water through the first passageway, the flexible water hose, and the third passageway;
(b) a second connection on the first hose end connector for connecting a source of breathable gas through the second passageway, the flexible gas hose, and the fourth passageway;
(c) a third connection on the second hose end connector for connecting the breathable gas hose to a pressure regulator as part of a user's breathing apparatus, and
(d) a fourth connection on the second hose end connector connecting a nozzle adaptor 8 for dispensing water connected to the third passageway.

3. The apparatus of claim 2, wherein the second connection having a valve for sealing the inlet end when disconnected and for providing breathable gas when connected to the source of breathable gas.

4. The apparatus of claim 2 wherein the gas hose is able to withstand an internal pressure of the breathable gas of at least 200 psig.

5. The apparatus of claim 1 having a length which enables fighting a fire with a connection to at least one standard water hose.

6. The apparatus of claim 1 wherein the breathable gas is supplied at a pressure of at least 110 psi.

7. The apparatus of claim 1 wherein the hose is constructed of material which does not have memory.

8. A system which allows a hose apparatus to be used to deliver water and air to the user at all times, the system comprising a hose apparatus having:
(a) an inlet end;
(b) an outlet end;
(c) a first hose end connector attached to the inlet end having a first passageway and a second passageway;
(d) a second hose end connector attached to the outlet end having a third passageway and a fourth passageway;
(e) a flexible water hose between and connected to the first passageway on the inlet end and the third passageway on the outlet end in a water tight connection:
(f) a flexible gas hose between and connected to the second passageway and the fourth passageway in a gas tight connection, adjacent to but external to the flexible water hose; and
(g) an outer jacket made of weather-resistant material, surrounding both the flexible water hose and the flexible gas hose, collectively.

9. The system of claim 8 further comprising the use of air tanks carried on the back of the user in conjunction with the apparatus, wherein the apparatus 101 provides gas at a pressure of at least 110 psi and wherein the air tanks include a pressure regulator 50 and a valve 51 which opens when air pressure from the apparatus 101 is below 110 psi.

10. The system of claim 8 having one hose apparatus.

11. The system of claim 10 wherein the hose apparatus is configured to be connected to at least one standard water hose.

12. A method for fighting fire which comprises the steps of:
(a) providing a hose apparatus 101 having an inlet end and an outlet end, and further comprising:
i. a first hose end connector attached to the inlet end having a first passageway and a second passageway;
ii. a second hose end connector attached to the outlet end having a third passageway and a fourth passageway;
iii. a flexible water hose between and connected to the first passageway on the inlet end and the third passageway on the outlet end in a water tight connection:
iv. a flexible gas hose between and connected to the second passageway and the fourth passageway in a gas tight connection, adjacent to but external to the flexible water hose;
v. an outer jacket made of weather-resistant material, surrounding both the flexible water hose and the flexible gas hose;
vi. a first connection on the first hose end connector for connecting a source of water through the first passageway, the flexible water hose, and the third passageway;
vii. a second connection on the first hose end connector for connecting a source of breathable gas through the second passageway, the flexible gas hose, and the fourth passageway, the second connection having a valve for sealing the inlet end when disconnected and for providing breathable gas when connected to the source of breathable gas;
viii. a third connection on the second hose end connector for connecting the breathable gas to a pressure regulator as part of a user's breathing apparatus wherein the gas hose is able to withstand an external water pressure in the water hose without collapsing and an internal pressure of the breathable gas of at least 200 psig, and
ix. a fourth connection on the second hose end connector 5 connecting a nozzle 40 for dispensing water connected to the third passageway.

13. The method of claim 12 wherein the breathable gas is at a pressure of between −75 to 5000 psig.

14. The method of claim 11 wherein the inlet end of the hose apparatus is connected to one end of a standard water hose and wherein the other end of the standard water hose is connected to the water source.
